(19) United States
(12) Patent Application Publication
(10) Pub. No.: US 2024/0196182 A1
(43) Pub. Date: Jun. 13, 2024

(54) METHOD AND APPARATUS FOR HANDLING OPERATION IN STANDALONE NON-PUBLIC NETWORK (SNPN)

(71) Applicant: SAMSUNG ELECTRONICS CO., LTD., Suwon-si (KR)

(72) Inventors: Lalith KUMAR, Suwon-si (KR); Danish Ehsan HASHMI, Suwon-si (KR); Govind Irappa UTTUR, Suwon-si (KR); Utsav SINHA, Suwon-si (KR); Vijay Kumar MISHRA, Suwon-si (KR)

(21) Appl. No.: 18/531,556

(22) Filed: Dec. 6, 2023

(30) Foreign Application Priority Data
Dec. 8, 2022 (IN) 202241070982
Dec. 9, 2022 (IN) 202241071222
Nov. 21, 2023 (IN) 202241070982

(51) Int. Cl. H04W 4/90; H04W 36/08

(52) U.S. Cl. CPC H04W 4/90; H04W 36/08

(57) ABSTRACT

The disclosure relates to a 5G or 6G communication system for supporting a higher data transmission rate. The present disclosure is for handling operation in standalone non-public network (SNPN). Embodiments herein disclose methods for handling an operation in a standalone non-public network (SNPN) by a UE. The method includes determining that a dialed number is an emergency number. Further, the method includes determining a current SNPN does not support an emergency service for the dialed number. Further, the method includes performing a deregistration procedure upon determining that the current SNPN does not support the emergency service for the dialed number. Further, the method includes selecting at least one of a cell and a public land mobile network (PLMN) that provides the emergency service to the UE after performing the deregistration procedure.

### CROSS-REFERENCE TO RELATED APPLICATIONS

This application is based on and claims priority under 35 U.S.C. § 119 to Indian Provisional Patent Application Nos. 202241070982 and 202241071222, filed on Dec. 8, 2022, and Dec. 9, 2022 and Indian Non-Provisional Patent Application No. 202241070982 filed on Nov. 21, 2023 in the Indian Patent Office, the disclosure of which are incorporated by reference herein in their entirety.

### BACKGROUND

### 1. Field

Embodiments disclosed herein relate to wireless networks, and more particularly to handling emergency calls, when onboarding is ongoing in stand-alone non-public networks (SNPNs), more particularly, to a system and methods of handling last registered stand-alone non-public network (SNPN).

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The principal object of the embodiments herein is to handle an operation in a standalone non-public network (SNPN).

Another object of the embodiments herein is to handle emergency calls, when a UE (which is SNPN enabled) is being onboarded in the SNPNs.

Another object of the embodiments herein is to handle a last registered SNPN.

Another object of the embodiments herein is to prioritize to select subscribed SNPN and not the registered SNPN during switch ON procedure or operating in a SNPN access mode procedure.

The present disclosure has been made to address at least the above problems and/or disadvantages and to provide at least the advantages described below. Accordingly, an aspect of the present disclosure provides a method and apparatus for handling operation in standalone non-public network (SNPN).

Accordingly, the embodiments herein provide methods for handling an operation in a SNPN. The method includes determining, by a UE, that a dialled number is an emergency number. Further, the method includes determining, by the UE, a current SNPN does not support an emergency service for the dialled number. Further, the method includes performing, by the UE, a deregistration procedure upon determining that the current SNPN does not support the emergency service for the dialled number. Further, the method includes selecting, by the UE, at least one of a cell and a public land mobile network (PLMN) that provides the emergency service to the UE after performing the deregistration procedure.

In an embodiment, the method includes placing, by the UE, the emergency service over a PS domain upon selecting at least one of the cell and the PLMN.

In an embodiment, the method includes establishing, by the UE, a protocol data unit (PDU) session for the emergency service upon selecting at least one of the cell and the PLMN. Further, the method includes continuing, by the UE, with the emergency service in at least one of the cell and the PLMN.

In an embodiment, the UE determines that the dialled number is the emergency number, when one of: the UE is registered for an onboarding service in the SNPN and the UE is registering for the onboarding service in the SNPN.

In an embodiment, the emergency service includes an emergency call and an emergency message.

In an embodiment, the deregistration procedure is one of a local deregistration or a deregistration with the network.

Accordingly, the embodiments herein provide methods for handling an operation in a SNPN. The method includes determining, by a UE, that the UE is in an automatic selection mode. Further, the method includes determining, by the UE, a coverage of a subscribed SNPN upon determining that the UE is in the automatic selection mode. Further, the method includes selecting and registering, by the UE, the subscribed SNPN based on the determination.

In an embodiment, the method includes stopping to return, by the UE, one of: a registered SNPN and an equivalent SNPN after determining a coverage of a subscribed SNPN is available.

In an embodiment, the UE is in the automatic selection mode, when the UE switched ON or the UE starts operation in a SNPN access mode or following recovery from lack of coverage or when the UE changes the entry of the list of subscriber data.

In an embodiment, selecting the subscribed SNPN indicates that UE selects and registers the subscribed SNPN for the selected entry of list of subscriber data.

Accordingly, the embodiments herein provide a UE including a SNPN based controller coupled with a processor and a memory. The SNPN based controller is configured to determine that a dialled number is an emergency number. Further, the SNPN based controller is configured to determine a current SNPN does not support an emergency service for the dialled number. Further, the SNPN based controller is configured to perform a deregistration procedure upon determining that the current SNPN does not support the emergency service for the dialled number. Further, the SNPN based controller is configured to select at least one of a cell and a PLMN that provides the emergency service to the UE after performing the deregistration procedure.

Accordingly, the embodiments herein provide a UE including a SNPN based controller coupled with a processor and a memory. The SNPN based controller is configured to determine that the UE is in an automatic selection mode. Further, the SNPN based controller is configured to determine a coverage of a subscribed SNPN upon determining that the UE is in the automatic selection mode. Further, the SNPN based controller is configured to select and register the subscribed SNPN based on the determination.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

Advantages, and salient features of the disclosure will become apparent to those skilled in the art from the following detailed description, which, taken in conjunction with the annexed drawings, discloses exemplary embodiments of the disclosure. For more enhanced communication system, there is a need for method and apparatus for handling operation in standalone non-public network (SNPN).

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates an example flow of events in existing methods while handling a last registered SNPN according to embodiments as disclosed herein;

FIG. 2 illustrates an example flow of events depicting the events in existing methods while handling a last registered SNPN according to embodiments as disclosed herein;

FIG. 3 illustrates an example scenario for enabling a UE to place emergency calls, where a UE cannot currently place an emergency call in an ON-SNPN, according to embodiments as disclosed herein;

FIG. 4 illustrates an example scenario for enabling the UE to place the emergency calls, where the UE cannot currently place the emergency call in the ON-SNPN, according to embodiments as disclosed herein;

FIG. 5 illustrates an example scenario for enabling the UE to place the emergency calls, where the UE cannot currently place the emergency call in the ON-SNPN as the SNPN does not support the emergency services, according to embodiments as disclosed herein;

FIG. 6 illustrates an example scenario, where the UE continues to place the emergency call in the same ON-SNPN, which supports emergency services, according to embodiments as disclosed herein;

FIG. 7 illustrates an example scenario, where the UE continues to place the emergency call in the same ON-SNPN, which supports emergency services, according to embodiments as disclosed herein;

FIG. 8 illustrates a flowchart showing exemplary method of handling a last registered SNPN according to embodiments as disclosed herein;

FIG. 9 illustrates a flowchart showing exemplary call flow while handling the last registered SNPN according to embodiments as disclosed herein;

FIG. 10 illustrates various hardware components of the UE according to the embodiments as disclosed herein;

FIG. 11 illustrates a flow chart of a method for handling the operation in the SNPN, while handling the emergency service during onboarding in the SNPN, according to the embodiments as disclosed herein;

FIG. 12 illustrates a flow chart of a method for handling the operation in the SNPN, while handling a last registered SNPN, according to the embodiments as disclosed herein;

FIG. 13 illustrates a UE in a wireless communication system according to embodiments as disclosed herein;

FIG. 14 illustrates a base station in a wireless communication system according to embodiments as disclosed herein; and

FIG. 15 illustrates a network entity according to embodiments as disclosed herein.

### DETAILED DESCRIPTION

The following specification particularly describes the disclosure and manner in which it is to be performed:

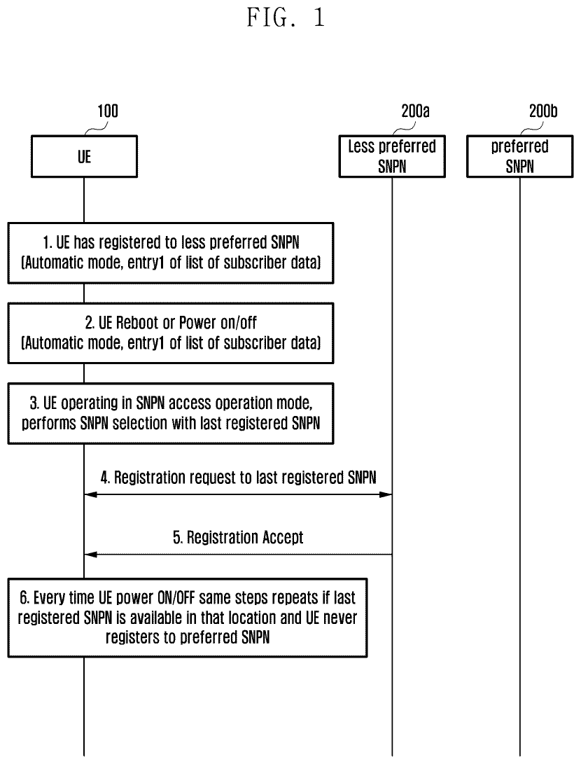

FIGS. 1 to 15 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present disclosure. For example, unless otherwise defined, the technical terms or scientific terms used in the disclosure shall have the ordinary meaning understood by those with ordinary skills in the art to which the present disclosure belongs.

It should be understood that “first,” “second” and similar words used in the disclosure do not express any order, quantity or importance, but are only used to distinguish different components. Similar words such as singular forms “a,” “an” or “the” do not express a limitation of quantity, but express the existence of at least one of the referenced items, unless the context clearly dictates otherwise. For example, reference to “a component surface” includes reference to one or more of such surfaces.

As used herein, any reference to “an example” or “example,” “an implementation” or “implementation,” “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper,” “lower,” “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies. In addition, the technical schemes of the embodiments of the present application can be applied to future-oriented communication technologies.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art and are not to be interpreted to have ideal or excessively formal meanings unless clearly defined in the present disclosure.

According to an aspect of an embodiment of the present disclosure, a method performed by a second node in a wireless communication system is provided, the method including: receiving, from a first node, a first message carrying related information of a UE in an RRC inactive state; and processing based on the first message.

According to an embodiment of the present disclosure, the related information of the UE in the RRC inactive state includes one of: an identifier of the UE; a number of UEs; indication information that there is the UE in the RRC inactive state; a session identifier of an MBS that the UE joins; state information of the MBS; configuration information of an MBS radio bearer (MRB); an area range; indication information of whether to support the UE in the RRC inactive state to receive an MBS service; indication information that MBS context information and/or configuration information continues to be maintained.

According to an embodiment of the present disclosure, the area range is a RAN paging range or a predetermined list of cells.

According to an embodiment of the present disclosure, the second node belongs to a same area range as the first node.

According to an embodiment of the present disclosure, the indication information that there is the UE in the RRC inactive state indicates that there is the UE in the RRC inactive state in a range of the first node or in an area range to which the first node belongs.

According to an embodiment of the present disclosure, the first message is a UE-specific message.

According to an embodiment of the present disclosure, the first message is one of:
a message dedicated to MBS multicast; a common message.

According to an embodiment of the present disclosure, the processing includes at least one of: maintaining, by the second node, UE context information; maintaining, by the second node, MBS context information; continuing, by the second node, a multicast data transmission; not releasing, by the second node, a signaling resource and/or a user plane resource of a multicast service; not initiating a multicast context release request message or not distributing a release command message to the first node by the second node.

According to an embodiment of the present disclosure, a number of the UEs in the RRC inactive state is at least 1.

According to an embodiment of the present disclosure, the UE in the RRC inactive state is at the first node or an area range to which the first node belongs.

According to an embodiment of the present disclosure, if the second node is a base station, the processing further includes at least one of: transmitting, to a core network, a request to establish a user plane; transmitting, to a third node, a third message carrying the related information of the UE in the RRC inactive state; transmitting, to the first node, a second message carrying the related information of the UE in the RRC inactive state.

According to an embodiment of the present disclosure, the third message includes the related information of the UE in the RRC inactive state of the second node and/or related information of the UE in the RRC inactive state of other received nodes.

According to an embodiment of the present disclosure, a number of the other received nodes is at least 1.

According to an embodiment of the present disclosure, the second node receives, from the third node, a response message carrying the related information of the UE in the RRC inactive state of the third node.

According to an embodiment of the present disclosure, MRB configuration information carried in the response message is the same as that carried in the third message.

According to an embodiment of the present disclosure, the second node is a base station, a distributed unit (DU) or a central unit (CU), and the first node is a base station or a central unit (CU).

According to another aspect of an embodiment of the present disclosure, a method performed by a second node in a wireless communication system is provided, the method including: receiving, from a first node, a first message carrying indication information of whether the first node can enable a UE in an RRC inactive state to receive an MBS service; transmitting a second message to the first node.

According to an embodiment of the present disclosure, the second message carries indicating whether the second node supports the UE in the RRC inactive state to receive the MBS service.

According to yet another aspect of an embodiment of the present disclosure, a node device in a wireless communication network is provided, including: a transceiver; and a processor coupled with the transceiver and configured to perform the methods as described according to the embodiments.

The principal object of the embodiments herein is to handle an operation in a standalone non-public network (SNPN).

Another object of the embodiments herein is to handle emergency calls, when a UE (which is SNPN enabled) is being onboarded in the SNPNs.

Another object of the embodiments herein is to handle a last registered SNPN.

Another object of the embodiments herein is to prioritize to select subscribed SNPN and not the registered SNPN during switch ON procedure or operating in a SNPN access mode procedure.

Accordingly, the embodiments herein provide methods for handling an operation in a SNPN. The method includes determining, by a UE, that a dialled number is an emergency number. Further, the method includes determining, by the UE, a current SNPN does not support an emergency service for the dialled number. Further, the method includes performing, by the UE, a deregistration procedure upon determining that the current SNPN does not support the emergency service for the dialled number. Further, the method includes selecting, by the UE, at least one of a cell and a public land mobile network (PLMN) that provides the emergency service to the UE after performing the deregistration procedure.

In an embodiment, the method includes placing, by the UE, the emergency service over a PS domain upon selecting at least one of the cell and the PLMN.

In an embodiment, the method includes establishing, by the UE, a Protocol Data Unit (PDU) session for the emergency service upon selecting at least one of the cell and the PLMN. Further, the method includes continuing, by the UE, with the emergency service in at least one of the cell and the PLMN.

In an embodiment, the UE determines that the dialled number is the emergency number, when one of: the UE is registered for an onboarding service in the SNPN and the UE is registering for the onboarding service in the SNPN.

In an embodiment, the emergency service includes an emergency call and an emergency message.

In an embodiment, the deregistration procedure is one of a local deregistration or a deregistration with the network.

Accordingly, the embodiments herein provide methods for handling an operation in a SNPN. The method includes determining, by a UE, that the UE is in an automatic selection mode. Further, the method includes determining, by the UE, a coverage of a subscribed SNPN upon determining that the UE is in the automatic selection mode. Further, the method includes selecting and registering, by the UE, the subscribed SNPN based on the determination.

In an embodiment, the method includes stopping to return, by the UE, one of: a registered SNPN and an equivalent SNPN after determining a coverage of a subscribed SNPN is available.

In an embodiment, the UE is in the automatic selection mode, when the UE switched ON or the UE starts operation in a SNPN access mode or following recovery from lack of coverage or when the UE changes the entry of the list of subscriber data.

In an embodiment, selecting the subscribed SNPN indicates that UE selects and registers the subscribed SNPN for the selected entry of list of subscriber data.

Accordingly, the embodiments herein provide a UE including a SNPN based controller coupled with a processor and a memory. The SNPN based controller is configured to determine that a dialled number is an emergency number. Further, the SNPN based controller is configured to determine a current SNPN does not support an emergency service for the dialled number. Further, the SNPN based controller is configured to perform a deregistration procedure upon determining that the current SNPN does not support the emergency service for the dialled number. Further, the SNPN based controller is configured to select at least one of a cell and a PLMN that provides the emergency service to the UE after performing the deregistration procedure.

Accordingly, the embodiments herein provide a UE including a SNPN based controller coupled with a processor and a memory. The SNPN based controller is configured to determine that the UE is in an automatic selection mode. Further, the SNPN based controller is configured to determine a coverage of a subscribed SNPN upon determining that the UE is in the automatic selection mode. Further, the SNPN based controller is configured to select and register the subscribed SNPN based on the determination.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

A 3rd generation partnership project (3GPP) onboarding of UEs for SNPNs allows the UE to access an onboarding network (ONN) for a purpose of provisioning the UE with SNPN credentials for primary authentication and other information to enable access to a desired SNPN, i.e., (re-)select and (re-)register with the SNPNs. To provision the SNPN credentials in the UE that is configured with Default UE credentials (see technical specification (TS) 23.501), the UE selects the SNPN as the ONN and establishes a secure connection with that SNPN referred to as onboarding SNPN (ON-SNPN) (as disclosed in TS 23.501). Based on ON-SNPN policies, an access and mobility management function (AMF) entity may start an implementation specific timer, once the UE has registered with the ON-SNPN for the purpose of onboarding. Expiry of the timer triggers the AMF entity to deregister the onboarding registered UE from the ON-SNPN.

This specific timer is used to prevent onboarding registered UEs from staying at the ON-SNPN indefinitely. To perform configuration of SNPN parameters via user plane, the UE that is configured with a universal subscriber identity module (USIM) with PLMN credentials, the UE selects and registers in the PLMN for the same. After successfully registering to the ON-PLMN, the UE is provisioned with the SO-SNPN credentials via the user plane as in TS 23.501. When the onboarding network is the PLMN and the UE's subscription only allows for remote provisioning, then based on PLMN policies, the AMF entity can start an implementation specific timer once the UE has registered to the PLMN. Expiry of this timer triggers the AMF entity to deregister the UE from the PLMN. This specific timer is used to prevent registered UEs that are only allowed for remote provisioning from staying at the PLMN indefinitely.

The UE is considered as “registered for onboarding services in SNPN” when the UE has successfully completed initial registration for onboarding services in the SNPN. While registered for the onboarding services in the SNPN, the services other than the onboarding services are not available.

When the SNPN enabled UE is registered for the Onboarding services, if the user of the UE triggers the emergency call, how the UE should handle it is not clarified in prior art and can impact the emergency services or at least delay in establishing the emergency call which is not desirable. There can be following scenarios:
1. Case A. Emergency call is supported by the onboarding SNPN where the UE is registered for the Onboarding services.
2. Case B. Emergency call is not supported by the onboarding SNPN where the UE is registered for Onboarding services.
3. Case C. Emergency call is supported by the onboarding SNPN where the UE is registered for Onboarding services in the SNPN, but UE is not allowed to make an emergency call as, while registered for onboarding services in SNPN, services other than the onboarding services are not available for the UE; i.e., the UE is not allowed to avail other services.

When the onboarding network is the SNPN, based on the ON-SNPN policies, the AMF entity may start an implementation specific timer once the UE has registered to the ON-SNPN for the purpose of onboarding. Expiry of the timer triggers the AMF entity to deregister the onboarding registered UE from the ON-SNPN impacting the emergency services.

When the onboarding network is the PLMN and the UE's subscription only allows for remote provisioning, then based on PLMN policies, the AMF entity can start the implementation specific timer once the UE has registered to the PLMN. Expiry of this timer triggers the AMF entity to deregister the UE from the PLMN impacting the emergency services.

The UE enabled for the SNPN may operate in a SNPN access mode and may support access to the SNPN using credentials from a credential holder. The Mobile Station (MS) can have several sets of subscriber identifiers, credentials, SNPN identities, and other parameters related to SNPN selection. There are two modes for SNPN selection, namely, automatic SNPN selection mode & manual SNPN selection mode.

At switch on, following recovery from lack of coverage, or when the MS starts operating in the SNPN access mode, the MS selects the registered SNPN (if the registered SNPN is available) using new radio-radio access network (NG-RAN) access technology. The MS in the automatic SNPN selection mode can end the SNPN search procedure once the registered SNPN is found on NG-RAN access technology. The MS may select one entry in the “list of subscriber data,” if any, or the PLMN subscription, if any, to be used for automatic SNPN selection.

The UE with two or more network subscriptions, where one or more network subscriptions may be for a subscribed SNPN, can apply procedures specified for multi-USIM UEs as described in 3GPP standard specification. The UE may use a separate PEI for each network subscription when the UE registers to the network.

The UE operating in SNPN access mode with automatic SNPN selection mode, successfully registered to SNPN. If the UE reboot or power ON/OFF, as per current specification UE may always register to last registered SNPN when the same entry of list of subscriber data is selected.

With the UE selecting last registered SNPN every time and as per current specification there is no high priority PLMN search defined, the UE may end up registering on same (less preferred) SNPN in that location, which is not correct.

The MS selects the SNPN, if available and allowable, in the following order:
a) the SNPN with which the UE was last registered;
b) the SNPN identified by an SNPN identity of the subscribed SNPN in the selected entry of the “list of subscriber data” in the ME, if any; and
c) if the MS supports access to the SNPN using credentials from the credentials holder, using the SNPN selection parameters in the selected entry of the “list of subscriber data” or associated with the selected PLMN subscription.

Each SNPN which broadcasts the indication that access using credentials from the credentials holder is supported and which is identified by the SNPN identity contained in the user controlled prioritized list of preferred SNPNs (in priority order).

Each SNPN which broadcasts the indication that access using credentials from the credentials holder is supported and which is identified by the SNPN identity contained in the credential holder controlled prioritized list of preferred SNPNs (in priority order).

Each SNPN which broadcasts the indication that access using credentials from the credentials holder is supported and which broadcast a GIN contained in the credential holder controlled prioritized list of GINs (in priority order). If more than one such SNPN broadcast the same GIN, the order in which the MS attempts registration on those SNPNs is MS implementation specific.

Each SNPN identified by the SNPN identity which is included neither in the SNPN selection parameters of the entries of the “list of subscriber data” nor in the SNPN selection parameters associated with the PLMN subscription, which does not broadcast the GIN which is included in the credentials holder controlled prioritized list of GINs, and which broadcasts an indication that the SNPN allows registration attempts from MSs that are not explicitly configured to select the SNPN. If more than one such SNPN is available, the order in which the MS attempts registration on those SNPNs is the MS implementation specific.

FIG. 1 illustrates an example flow of events in existing methods, while handling a last registered SNPN, according to embodiments as disclosed herein. At step 1, the UE (100) has registered to a less preferred SNPN (200a) in the automatic mode with an entry1 of list of subscriber data. At step 2, the UE (100) reboots or power cycles or a Low Power Mode (LPM) ON/OFF. At step 3, the UE (100) operating in a SNPN access operation mode and performs the SNPN selection with the last registered SNPN. At step 4, the UE (100) performs registration procedure with the last registered SNPN. At step 5, the UE (100) receives the registration accept from the less preferred SNPN (200a). At step 6, every time, the UE (100) powers ON/OFF, same steps repeats if the last registered SNPN is available in that location and the UE (100) never registers to the preferred SNPN (200b).

The UE (100) operating in the SNPN access mode with the automatic SNPN selection mode, successfully registered to the SNPN. If the UE (100) reboot or powers ON/OFF, as per current specification UE (100) may always start SNPN selection with the last registered SNPN in the selected entry of list of subscriber data.

With the UE (100) selecting the last registered SNPN every time and as per current specification there is no high priority PLMN search defined, the UE (100) may end up registering on same SNPN (i.e., less preferred SNPN (200a)) in that location, which is not correct. This is a critical difference when compared to the PLMN selection in which the higher priority PLMN search is supported, even though the UE registers with last registered PLMN UE may perform a higher priority PLMN search procedure whenever the timer T expires and the UE can go back to the higher priority PLMN but no such procedure is defined for the SNPN which is a private network. Thus, it is important for the UE to select the correct SNPN when the UE first starts the search after the switch off and switch on procedure.

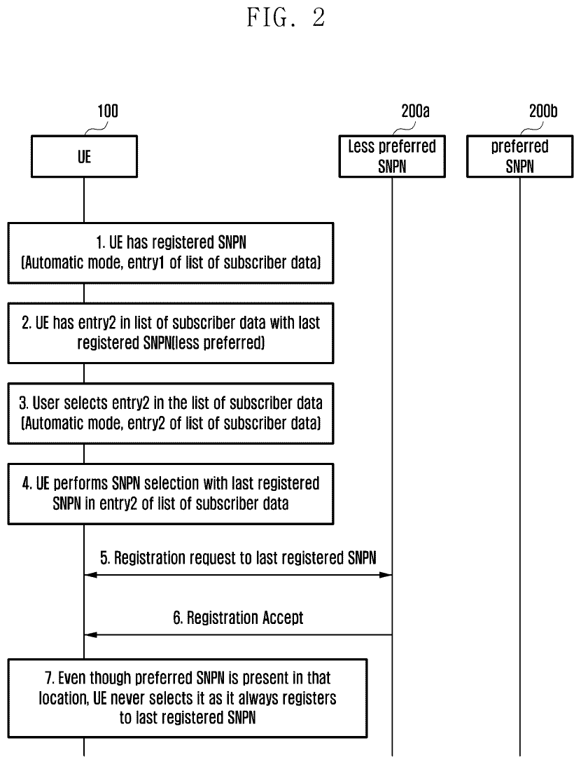

FIG. 2 illustrates an example flow of events depicting the events in existing methods, while handling the last registered SNPN, according to embodiments as disclosed herein. At step 1, the UE (100) has registered the SNPN in the automatic mode with the entry1 of list of subscriber data. At step 2, the UE (100) has an entry 2 in list of subscriber data with the last registered SNPN (i.e., less preferred SNPN (200a)). At step 3, the user of the UE (100) selects the entry 2 in the list of subscriber data in the automatic mode with the entry 2 of list of subscriber data. At step 4, the UE (100) performs the SNPN selection with the last registered SNPN in the entry 2 of list of subscriber data. At step 5, the UE (100) sends the registration request to the last registered SNPN. At step 6, the UE (100) receives the registration accept from the last registered SNPN based on the registration request. At step 7, even though the preferred SNPN (200b) is present in that location, the UE (100) never selects the preferred SNPN (200b) as the UE (100) always registers to last registered SNPN.

The above is illustrated by taking switch of subscription between entry of list of subscriber data. i.e., from entry-1 of list of subscriber data to the entry-2 of list of subscriber data. Same concept is applicable when there is a switch of subscription between the USIM to entry of list of subscriber data and vice versa.

The UE (100) with two or more network subscriptions, where one or more network subscriptions may be for the subscribed SNPN, can apply procedures specified for multi-USIM UEs as described in 3GPP standard specification. The UE (100) may use a separate PEI for each network subscription when the UE registers to the network.

The UE (100) operating in the SNPN access mode with the automatic SNPN selection mode, successfully registered to the SNPN (using entry 1 of list of subscriber data & PEI-1). If the user of the UE (100) selects different entry of list of subscriber data (For example: entry2 of list of subscriber data with PEI-1 or entry 1 of list of subscriber data with PEI-1 or entry2 of list of subscriber data with PEI-2) PEI, as per current specification, the UE (100) may always starts SNPN selection with the last registered SNPN in the selected entry of list of subscriber data.

With the UE (100) selecting the last registered SNPN from the selected entry of list of subscriber data every time and as per current specification there is no high priority PLMN search defined, the UE (100) may end up registering on same SNPN (i.e., less preferred SNPN (200a)) in that location, which is not correct.

Thus, it is desired to address one or more of the above-mentioned disadvantages or other shortcomings and at least provide a useful alternative.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

For the purposes of interpreting this specification, the definitions (as defined herein) may apply and whenever appropriate the terms used in singular will also include the plural and vice versa. It is to be understood that the terminology used herein is for the purposes of describing particular embodiments only and is not intended to be limiting. The terms “comprising,” “having” and “including” are to be construed as open-ended terms unless otherwise noted.

The words/phrases “exemplary,” “example,” “illustration,” “in an instance,” “and the like,” “and so on,” “etc.,” “etcetera,” “e.g.,” “i.e.,” are merely used herein to mean “serving as an example, instance, or illustration.” Any embodiment or implementation of the present subject matter described herein using the words/phrases “exemplary,” “example,” “illustration,” “in an instance,” “and the like,” “and so on,” “etc.,” “etcetera,” “e.g.,” ““i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The terms UE and MS are used interchangeably in this embodiment and have same meaning. The terms power ON and switch ON are used interchangeably in this embodiment and have same meaning. The terms power OFF and switch OFF are used interchangeably in this embodiment and have same meaning.

The following definitions and abbreviations have been referred to herein:
UE: User Equipment;
NW: Network;
SNPN: Stand-alone non-Public Network;
PLMN: Public Land Mobile Network;
AMF entity: Access & Mobility Management Function entity;
ON-SNPN: Onboarding Standalone Non-Public Network;
PLMN: Public Land Mobile Network;
USIM: Universal Subscriber Identity Module; and
PEI: Permanent Equipment Identifier.

The embodiments herein achieve methods for handling an operation in a SNPN. The method includes determining, by a UE, that a dialled number is an emergency number. Further, the method includes determining, by the UE, a current SNPN does not support an emergency service for the dialled number. Further, the method includes performing, by the UE, a local deregistration procedure upon determining that the current SNPN does not support the emergency service for the dialled number. Further, the method includes selecting, by the UE, at least one of a cell and a PLMN that provides the emergency service to the UE after performing the deregistration procedure.

The proposed methods can be used for handling the emergency calls, when the UE (which is SNPN enabled) is being onboarded in Stand-alone Non-Public Networks (SNPNs). The proposed method allows the UE to handle the emergency call while registered for onboarding services in the SNPN. The proposed method allows the UE to handle the emergency call while registered for onboarding services, a state in which no other services are allowed to the UE.

The UE selects and registers in subscribed SNPN of the entry of the “list of subscriber data” instead of the last registered SNPN. This gives the UE for a new mechanism to select a higher priority SNPN above the registered SNPN after power-up, out of service recovery and when the UE starts operating in the SNPN access operation mode.

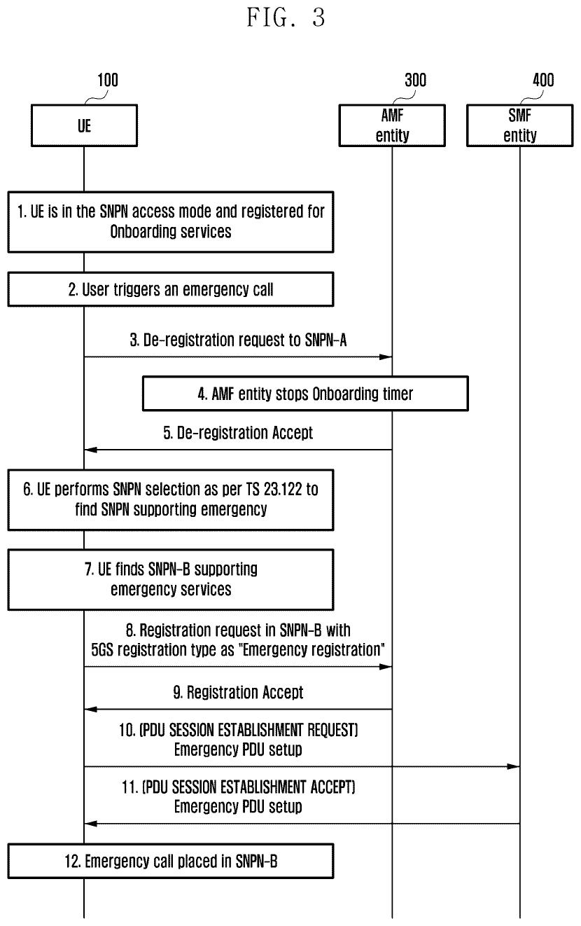

Referring now to the drawings, and more particularly to FIGS. 3 through 12, where similar reference characters denote corresponding features consistently throughout the figures, there are shown at least one embodiment.

FIG. 3 illustrates an example scenario for enabling a UE (100) to place emergency calls, where the UE (100) cannot currently place an emergency call in the ON-SNPN, according to embodiments as disclosed herein. The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IOT) device.

At least one of the below steps are executed by the UE (100) in any combination for the one or more cases described in this embodiment or in general whenever the UE (100) triggers an emergency call when registered or registering for onboarding services:
a) The UE (100) may perform SNPN selection or PLMN selection as specified in TS 23.122, cell selection or cell reselection to select a PLMN or SNPN or a cell/Tracking Area identity (TAI) which can provide emergency services (i.e., to a network which supports emergency services to the UE) to the UE (100). This may result in the UE (100) leaving the current registered SNPN. On the selection of appropriate PLMN or SNPN, the UE (100) triggers a non access stratum (NAS) procedure; for e.g., Registration procedure with 5GS registration type as “Emergency registration” to register for emergency services;
b) Perform de-registration procedure, the UE can either perform deregistration procedure by itself also called as locally or optionally with the network, to indicate to the AMF entity (300) that the UE (100) is not registered for Onboarding services any further;
c) Deactivate the SNPN access mode. In this case, the UE (100) may perform SNPN selection or PLMN selection, cell (re)selection as per TS 23.122. 38.331, 38.304 to select a PLMN that supports emergency services. After successfully registering (optionally, registering for emergency services) in the PLMN or the SNPN, the UE (100) may setup the PDU for emergency services, and continue with emergency call in the PLMN;
d) The UE (100) may abort the ongoing onboarding procedure; for example, the UE (100) may not initiate PDU establishment procedure for remote provisioning of SNPN parameters. Or, if the onboarding PDU is already setup, the UE (100) may not continue with remote provisioning of SNPN parameters & optionally release the onboarding PDU or not continue to establish user plane resources to download provisioning information or like so;
e) The UE (100) can trigger a NAS procedure; for e.g., Registration procedure with 5GS registration type as “emergency registration” to indicate to the AMF entity (300) that the UE (100) is not registered for Onboarding services anymore, i.e., switch from registered for onboarding services to emergency services. Optionally, once an acknowledgement is received from the network; for example, as registration accept message or an indication in the NAS message, that the UE (100) is registered for emergency services in one of the NAS message, the UE (100) can start procedures to establish the emergency call; for e.g., by initiating the establishment of the emergency PDU session;
f) Stop the implementation specific timer for the onboarding services started by the AMF entity (300) after the UE (100) is registered for onboarding (or for the cases described in TS 24.501) when the UE (100) tries to establish a PDU session for emergency services (e.g., PDU session for emergency service is established or is being established) or if the UE (100) triggers registration for emergency service procedure or any of the NAS procedure which is related to emergency services;
g) Pause the implementation specific timer at the AMF entity (300) once the UE (100) starts procedures for the emergency call for example establishing a PDU session for emergency services. After the emergency call or the emergency service is released (for e.g., PDU session for emergency service is released), the AMF entity (300) can (re-)start timer or start the timer. Optionally, this case is applicable when the UE (100) starts the emergency call in the same SNPN or the PLMN where the UE was registered for Onboarding services; and
h) The AMF entity (300) is allowed to continue and run the implementation specific timer started after UE (100) was successfully registered for onboarding services, even after successful establishment of PDU for emergency services. If the timer expires during an ongoing emergency call or when emergency services are ongoing, the AMF entity (300) may not de-register the UE (100). Optionally, the AMF entity (300) can send a configuration update command to the UE (100) indicating that it is “Registered for emergency services.” The UE (100) may remain registered for emergency services as described in TS 24.501.

The UE (100) is registered for the onboarding services when the UE (100) performs the initial registration for the onboarding services in the SNPN for example when the UE (100) indicates “SNPN onboarding registration” in the 5GS registration type IE.

It performs a de-registration procedure with the ON-SNPN to indicate it is not registered for onboarding services anymore. Then, the UE (100) performs the SNPN selection to find the SNPN that supports the emergency service, sets up an emergency PDU & continues to place emergency call in that SNPN.

At step 1, the UE (100) is in the SNPN access mode and registered for the onboarding services. At step 2, the user of the UE (100) triggers the emergency call. At step 3, the UE (100) optionally sends the de-registration request to the SNPN-A. At step 4, the AMF entity (300) stops the onboarding timer. At step 5, the AMF entity (300) sends the de-registration accept to the UE (100). At step 6, the UE (100) performs the SNPN selection as per TS 23.122 to find the SNPN supporting emergency. At step 7, the UE (100) finds the SNPN-B supporting emergency services. At step 8, the UE (100) sends the registration request in the SNPN-B with the 5GS registration type as “Emergency registration.” At step 9, the UE (100) receives the registration accept from the AMF entity (300).

At step 10, the UE (100) sends the PDU session establishment request for the emergency PDU setup to the SMF entity (400). At step 11, the UE (100) receives the PDU session establishment accept for the emergency PDU setup from the SMF entity (400). At step 12, the emergency call placed in the SNPN-B at the UE (100).

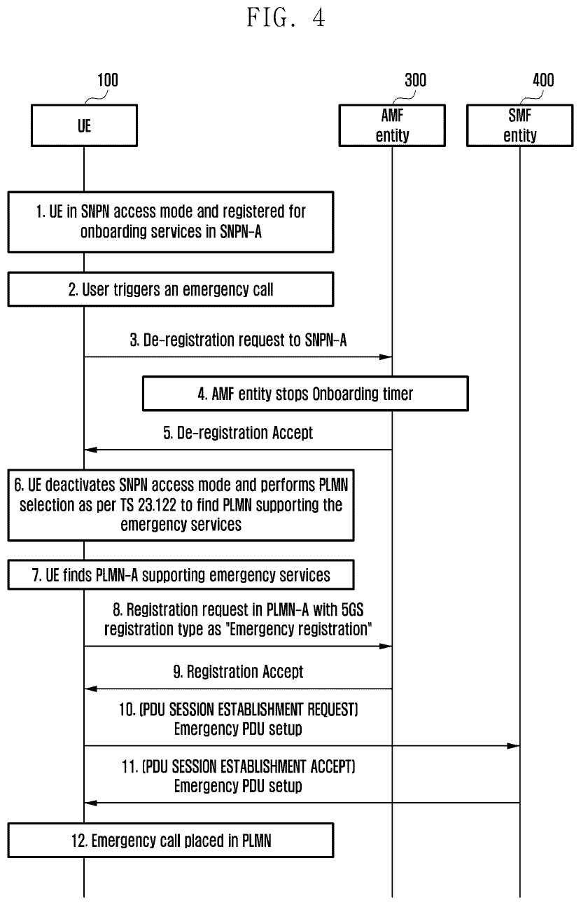

FIG. 4 illustrates an example scenario for enabling the UE (100) to place emergency calls, where the UE (100) cannot currently place an emergency call in the ON-SNPN, according to embodiments as disclosed herein. It performs a de-registration procedure with the ON-SNPN to indicate it is not registered for onboarding services anymore. The deregistration procedure can be local or it can be indicated to the network optionally by sending the deregistration message. Then, the UE (100) deactivates the SNPN access mode, performs PLMN selection to find a PLMN that supports emergency service, and continues to place the emergency call in that PLMN.

At step 1, the UE (100) is in the SNPN access mode and registered for onboarding services in the SNPN-A. At step 2, the user of the UE (100) triggers the emergency call. At step 3, Optionally, the UE (100) sends the de-registration request to the SNPN-A. At step 4, the AMF entity (300) stops the onboarding timer. At step 5, the AMF entity (300) sends the de-registration accept message to the UE (100). At step 6, the UE (100) deactivates the SNPN access mode and performs the PLMN selection as per TS 23.122 to find PLMN supporting the emergency services.

At step 7, the UE (100) finds the PLMN-A supporting emergency services. At step 8, the UE (100) sends the registration request in the PLMN-A with 5GS registration type as “Emergency registration.” At step 9, the AMF entity (300) sends the registration accept to the UE (100). At step 10, the UE (100) sends the PDU session establishment request for the emergency PDU setup to the SMF entity (400). At step 11, the SMF entity (400) sends the PDU session establishment accept for the emergency PDU setup to the UE (100). At step 12, the emergency call placed in PLMN at the UE (100).

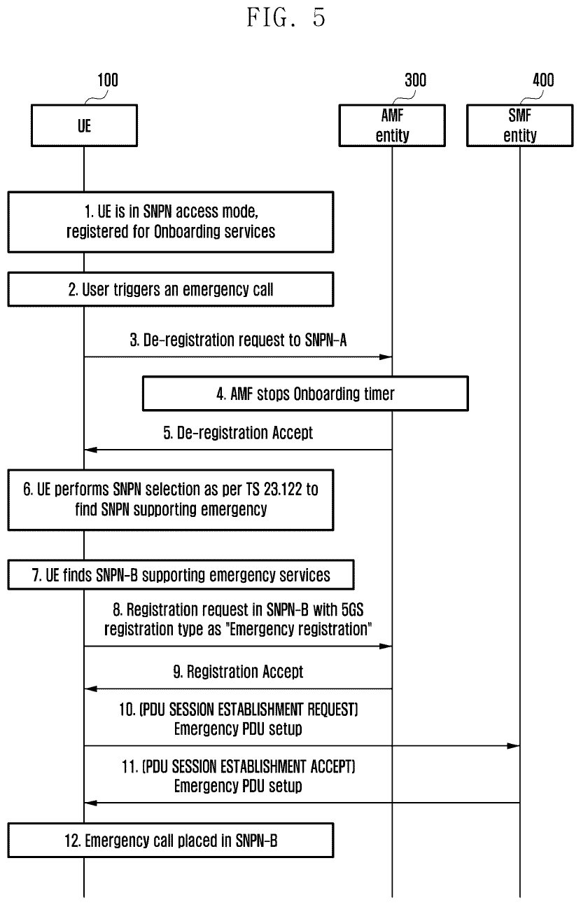

FIG. 5 illustrates an example scenario for enabling the UE (100) to place emergency calls, where the UE (100) cannot currently place an emergency call in the ON-SNPN as the SNPN does not support emergency services, according to embodiments as disclosed herein. The UE (100) performs de-registration in the ON-SNPN, the deregistration procedure can be locally done in the UE or indicate to network and finds another suitable SNPN supporting emergency and places the emergency call after the emergency PDU setup.

At step 1, the UE (100) is in the SNPN access mode and registered for the onboarding services. At step 2, the user of the UE (100) triggers the emergency call. At step 3, the UE (100) optionally sends the de-registration request to the SNPN-A or perform a local deregistration procedure i.e., in general the UE performs the deregistration procedure. At step 4, the AMF entity (300) stops the onboarding timer. At step 5, the AMF entity (300) sends the de-registration accept to the UE (100). At step 6, the UE (100) performs the SNPN selection as per TS 23.122 to find SNPN supporting emergency. At step 7, the UE (100) finds the SNPN-B supporting emergency services. At step 8, the UE (100) sends the registration request in the SNPN-B with 5GS registration type as “emergency registration” to the AMF entity (300). At step 9, the AMF entity (300) sends the registration accept to the UE (100). At step 10, the UE (100) sends the PDU session establishment request for the emergency PDU setup to the SMF entity (400). At step 11, the SMF entity (400) sends the PDU session establishment accept for the emergency PDU setup to the UE (100). At step 12, the emergency call placed in the SNPN-B at the UE (100).

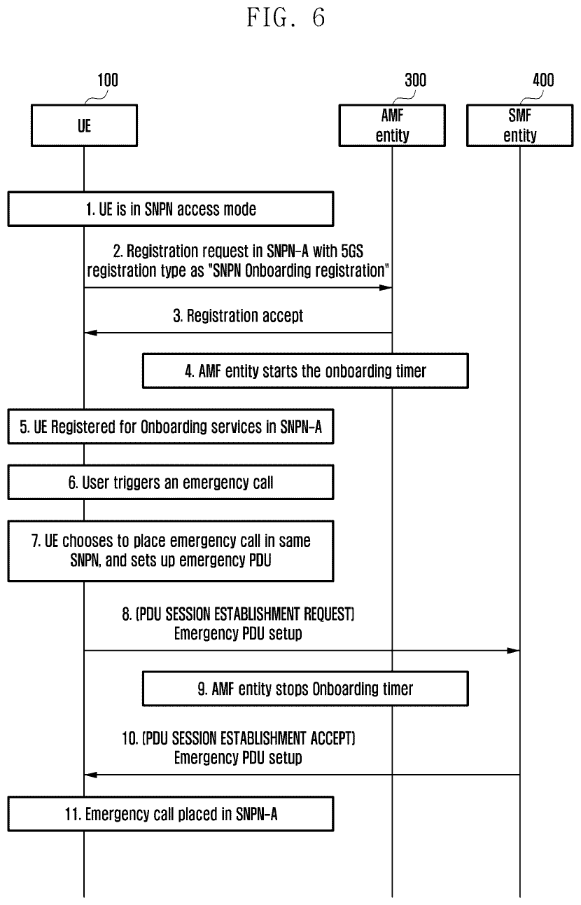

FIG. 6 illustrates an example scenario, where the UE (100) continues to place the emergency call in the same ON-SNPN, which supports emergency services. The AMF entity (300) stops the onboarding timer when the UE (100) initiates a PDU for emergency services and the UE (100) places emergency call after successful PDU establishment.

At step 1, the UE (100) is in the SNPN access mode. At step 2, the UE (100) sends the registration request in the SNPN-A with 5GS registration type as “SNPN Onboarding registration” to the AMF entity (300). At step 3, the UE (100) receives the registration accept from the AMF entity (300). At step 4, the AMF entity (300) starts the onboarding timer. At step 5, the UE (100) is registered for the onboarding services in the SNPN-A. At step 6, the user of the UE (100) triggers the emergency call. At step 7, the UE (100) chooses to place the emergency call in same SNPN and sets up the emergency PDU.

At step 8, the UE (100) sends the PDU session establishment request for the emergency PDU setup to the SMF entity (400). At step 9, the AMF entity (300) stops the onboarding timer. At step 10, the SMF entity (400) sends the PDU SESSION ESTABLISHMENT ACCEPT to the emergency PDU setup to the UE (100). At step 11, the emergency call placed in the SNPN-A at the UE (100).

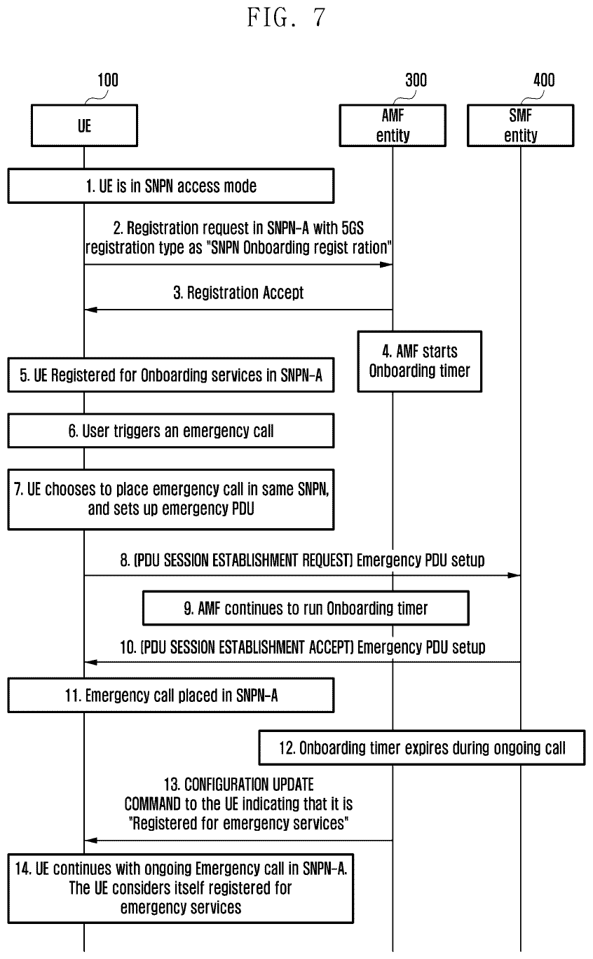

FIG. 7 illustrates an example scenario, where the UE (100) continues to place the emergency call in the same ON-SNPN, which supports emergency services. The AMF entity (300) continues to run the onboarding timer, when the UE (100) initiates a PDU for emergency services & the UE (100) places the emergency call after successful PDU establishment. On timer expiry the AMF entity (300) does not de-register the UE (100), and the AMF entity (300) sends a UE (100) configuration update command to indicate that the UE (100) is “Registered for emergency services.”

At step 1, the UE (100) is in the SNPN access mode. At step 2, the UE (100) sends the registration request in the SNPN-A with 5GS registration type as “SNPN Onboarding registration” to the AMF entity (300). At step 3, the UE (100) receives the registration accept from the AMF entity (300). At step 4, the AMF entity (300) starts the onboarding timer. At step 5, the UE (100) is registered for the onboarding services in the SNPN-A. At step 6, the user of the UE (100) triggers the emergency call. At step 7, the UE (100) chooses to place the emergency call in same SNPN and sets up the emergency PDU.

At step 8, the UE (100) sends the PDU session establishment request for the emergency PDU setup to the SMF entity (400). At step 9, the AMF entity (300) continues to run the onboarding timer. At step 10, the SMF entity (400) sends the PDU SESSION ESTABLISHMENT ACCEPT to the emergency PDU setup to the UE (100). At step 11, the emergency call placed in the SNPN-A at the UE (100). At step 12, the onboarding timer expires during ongoing call at the AMF entity (300) and the SMF entity (400). At step 13, the AMF entity (300) sends the configuration update command to the UE (100) indicating that the AMF entity (300) is “Registered for the emergency services.” At step 14, the UE (100) continues with the ongoing emergency call in SNPN-A. The UE (100) considers itself registered for the emergency services.

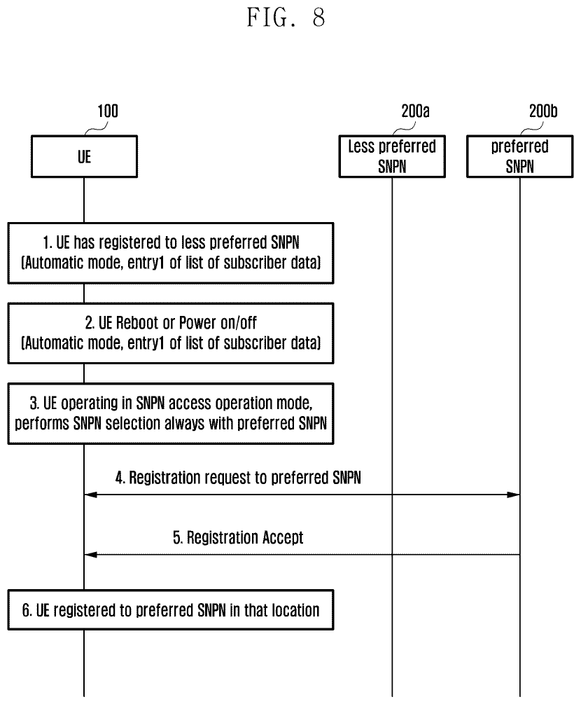

FIG. 8 illustrates a flowchart showing exemplary method of handling a last registered SNPN by the UE (100), according to embodiments as disclosed herein. The UE (100) that is operating in SNPN access mode may select the SNPN, if available (i.e., finds the coverage of the respective SNPN) and allowable, in the following order (i.e., the term preferred SNPN (200b) is the highest priority SNPN available following below priority order):
1. The SNPN identified by an SNPN identity of the subscribed SNPN in the selected entry of the “list of subscriber data” in the ME, if any;
2. If the MS supports access to an SNPN using credentials from a credentials holder, using the SNPN selection parameters in the selected entry of the “list of subscriber data” or associated with the selected PLMN subscription:
   1) Each SNPN which broadcasts the indication that access using credentials from a credentials holder is supported and which is identified by an SNPN identity contained in the user controlled prioritized list of preferred SNPNs (in priority order) (200b),
   2) Each SNPN which broadcasts the indication that access using credentials from a credentials holder is supported and which is identified by an SNPN identity contained in the credentials holder controlled prioritized list of preferred SNPNs (in priority order) (200b),
   3) Each SNPN which broadcasts the indication that access using credentials from a credentials holder is supported and which broadcast a GIN contained in the credentials holder controlled prioritized list of GINs (in priority order). If more than one such SNPN broadcast the same GIN, the order in which the MS attempts registration on those SNPNs is MS implementation specific, and
   4) Each SNPN identified by an SNPN identity which is included neither in the SNPN selection parameters of the entries of the “list of subscriber data” nor in the SNPN selection parameters associated with the PLMN subscription, which does not broadcast a GIN which is included in the credentials holder controlled prioritized list of GINs, and which broadcasts an indication that the SNPN allows registration attempts from MSs that are not explicitly configured to select the SNPN. If more than one such SNPN is available, the order in which the MS attempts registration on those SNPNs is MS implementation specific; and.
3. Optionally, the SNPN with which the UE (100) was last registered.

In an embodiment, the UE (100), after power/switch on or when the MS starts operating in the SNPN access operation mode, may perform the SNPN selection and select preferred SNPN (200b). As described in FIG. 8, at step 1, the UE (100) has registered to the less preferred SNPN (200a) in the automatic mode with selected entry 1 of list of subscriber data. At step 2, the UE (100) reboots or powers ON/OFF cycles or performs a Low Power Mode (LPM) ON/OFF or MS starts operating in the SNPN access operation mode. At step 3, the UE (100) operates in the SNPN access operation mode and performs the SNPN selection always with the preferred SNPN (200b). At step 4, the UE (100) sends the registration request to the preferred SNPN (200b). At step 5, the UE (100) receives the registration accept from the preferred SNPN (200b) based on the registration request. At step 6, the UE (100) is registered to the preferred SNPN (200b) in the location. That is, the UE (100) may ignore the last registered SNPN in this case (i.e., the ME may not return to the registered SNPN or equivalent SNPN).

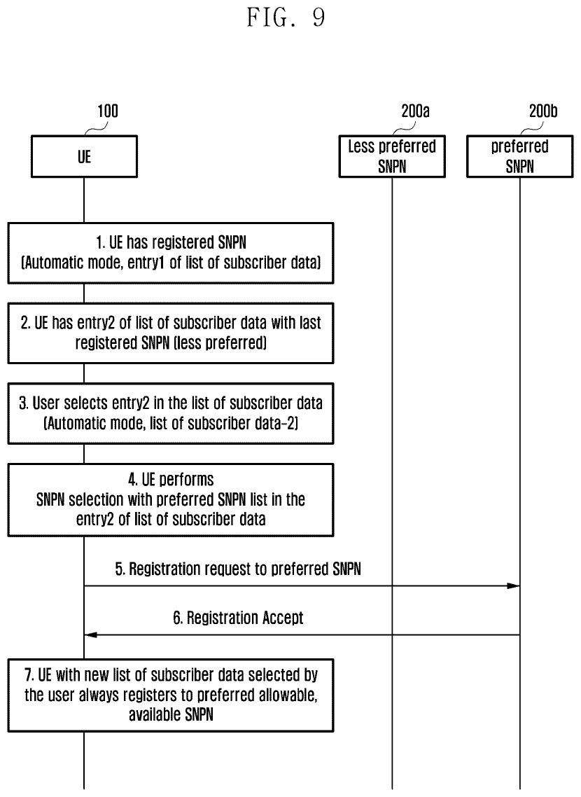

FIG. 9 illustrates a flowchart showing exemplary call flow while handling the last registered SNPN, according to embodiments as disclosed herein. In FIG. 9, after user of the UE (100) selects different entry in list of subscriber data, the UE (100) may perform SNPN selection with preferred SNPN list as below.

For the case each time a new entry of list of subscriber data is selected, the UE (100) may have a choice to ignore last Registered SNPN and start SNPN selection with preferred SNPN list so that at least once UE (100) attempts for priority SNPN.

At step 1, the UE (100) has registered SNPN in Automatic mode with entry 1 of list of subscriber data. At step 2, the UE (100) has entry2 in list of subscriber data with last registered SNPN (less preferred SNPN) (200a). At step 3, the user of the UE (100) selects entry2 in the list of subscriber data in Automatic mode. At step 4, the UE (100) may ignore last registered SNPN in the entry2 of list of subscriber data and performs SNPN selection with preferred SNPN list. At step 5, the UE (100) performs the Registration procedure with the preferred SNPN (200b). At step 6, the UE (100) receives the registration accept from the preferred SNPN (200b) based on the registration procedure. At step 7, the UE (100) with new list of subscriber data selected by the user always registers to preferred allowable, available SNPN.

In an embodiment, the UE (100) comprises two or more network subscriptions, where one or more network subscriptions may be for a subscribed SNPN, can apply procedures specified for multi-USIM UEs as described in 3GPP standard specification. The UE (100) may use a separate PEI for each network subscription when the UE registers to the network.

After power cycle, the last Registered SNPN may be selected only if the selected entry of list of subscriber data+PEI (optionally the selected PEI if there are multiple PEIs) combination is same as before power cycle (i.e., switch off and switch ON)

If the selected entry of list of subscriber data or PEI (optionally the selected PEI if there are multiple PEIs) is different, then the UE (100) may start SNPN selection with preferred SNPN list ignoring the last registered SNPN in the entry of list of subscriber data.

In an embodiment, if the MS is in automatic SNPN selection mode and the MS finds coverage of a subscribed SNPN or the preferred SNPN (200b), the MS may register to that subscribed SNPN or preferred SNPN (200b) and not return to the registered SNPN or equivalent SNPN. Optionally, the operator may be able to control by SIM configuration or configuration in the ME, whether an MS that supports this option is permitted to perform this alternative behavior. That is there can be a flag/indication/information element configured in the UE (100) (either in ME or USIM) which indicates to UE (100) that the UE may select last registered SNPN or the preferred SNPN (200b)/subscribed SNPN for the cases discussed in this embodiment example At switch-on or recovery from lack of coverage or when the UE (100) starts operating in the SNPN access mode or when the UE (100) selects another entry of the list of subscriber data..

The flag can be configured in the UE (100) using UE parameters update procedure (see TS 23.501/TS 23.502) or using UE configuration update procedure (see TS 23.501/TS 23.502) or steering of roaming procedure, through any of the NAS message/NAS procedure or over data path or using OTA mechanism (MO data) or SMS or any other mechanism. For illustration, following examples may be considered.

Flag name could be, ShouldRegSNPN-prioritized.
1. Value 0: Indicates to UE (100) that the UE may not select (deprioritize) the last registered SNPN even if its available, optionally, for all the cases described in this embodiment and select the subscribed SNPN or the preferred SNPN (200b).
2. Value 1: Indicates to UE (100) that the UE may select the last registered SNPN with priority if available, optionally, for all the cases described in this embodiment.
3. This flag is configured per entry of list of subscriber data.

In an embodiment, the term “not select” or “ignore” implies that the UE (100) may first attempt to select the preferred SNPN (200b) in the priority order. In other words, the UE (100) may start the SNPN selection ignoring last registered SNPN information maintaining all other SNPNs priority.

In an example, the UE (100) is configured with the last registered SNPN (i.e., SNPN-3) and subscribed the SNPN (i.e., SNPN-1). credentials holder controlled prioritized list of preferred SNPNs (in priority order): SNPN-2, SNPN-3, SNPN-4. If SNPN-1 is available, then UE (100) may select SNPN-1, ignoring the last registered SNPN-3. If SNPN-1 is not available, but SNPN-2 is available UE (100) may select SNPN-2. If both SNPN-1 and SNPN-2 are not available but SNPN-3 is available then UE (100) may select SNPN-3. i.e., UE (100) may ignore later registered SNPN information and follow the priority order configured in the UE (100).

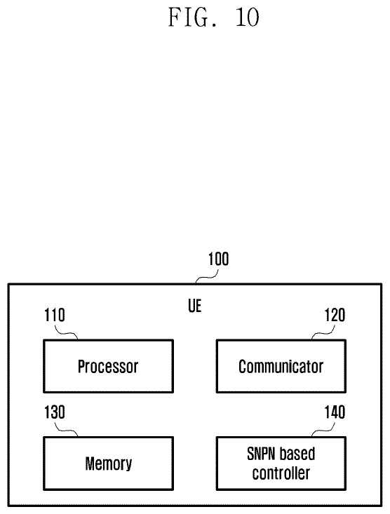

FIG. 10 illustrates various hardware components of the UE (100) according to the embodiments as disclosed herein. In an embodiment, the UE (100) includes a processor (110), a communicator (120), a memory (130) and a SNPN based controller (140). The processor (110) is coupled with the communicator (120), the memory (130) and the SNPN based controller (140).

The SNPN based controller (140) determines that the dialled number is the emergency number. In an embodiment, the UE (100) determines that the dialled number is the emergency number, when one of: the UE (100) is registered for the onboarding service in the SNPN and the UE (100) is registering for the onboarding service in the SNPN. Further, the SNPN based controller (140) determines the current SNPN does not support the emergency service for the dialled number. The emergency service can be, for example, but not limited to the emergency call and the emergency message. Further, the SNPN based controller (140) performs the deregistration procedure upon determining that the current SNPN does not support the emergency service for the dialled number. The deregistration procedure is one of the local deregistration or deregistration with the network. Further, the SNPN based controller (140) selects at least one of the cell and the PLMN that provides the emergency service to the UE (100) after performing the deregistration procedure.

In an embodiment, the SNPN based controller (140) places the emergency service over the PS domain upon selecting at least one of the cell and the PLMN.

In another embodiment, the SNPN based controller (140) sets the PDU for the emergency service upon selecting at least one of the cell and the PLMN. the SNPN based controller (140) continues with the emergency service in at least one of the cell and the PLMN.

In an embodiment, the SNPN based controller (140) determines that the UE (100) is in the automatic selection mode. In an embodiment, the UE (100) is in the automatic selection mode, when the UE (100) switched ON or the UE (100) starts operation in the SNPN access mode or following recovery from lack of coverage or when the UE (100) changes the entry of the list of subscriber data. Further, the SNPN based controller (140) determines the coverage of the subscribed SNPN upon determining that the UE (100) is in the automatic selection mode. Further, the SNPN based controller (140) selects and registers the subscribed SNPN based on the determination. In an embodiment, selecting the subscribed SNPN indicates that UE (100) selects and registers the subscribed SNPN for the selected entry of list of subscriber data. Further, the SNPN based controller (140) stops to return one of: the registered SNPN and the equivalent SNPN after determining a coverage of the subscribed SNPN is available.

The SNPN based controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 10 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the disclosure. One or more components can be combined together to perform same or substantially similar function in the UE (100).

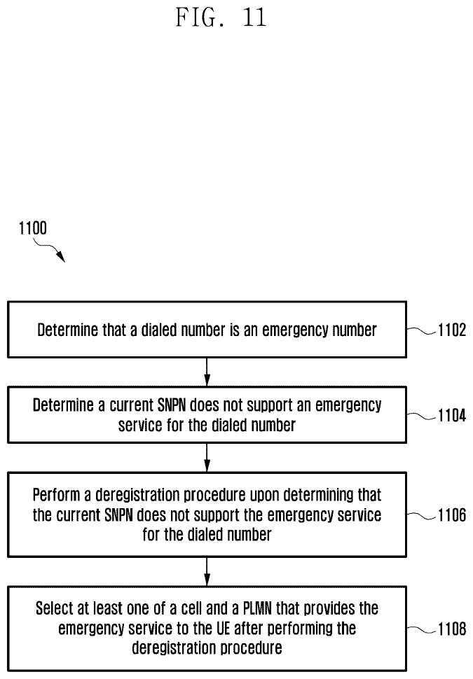

FIG. 11 illustrates a flow chart of a method for handling the operation in the SNPN, while handling the emergency service during onboarding in SNPN, according to the embodiments as disclosed herein. The operations (1102-1108) are handled by the SNPN based controller (140).

At step 1102, the method includes determining that the dialled number is the emergency number. At step 1104, the method includes determining the current SNPN does not support an emergency service for the dialled number. At step 1106, the method includes performing the deregistration procedure upon determining that the current SNPN does not support the emergency service for the dialled number. At step 1108, the method includes selecting the cell and the PLMN that provides the emergency service to the UE (100) after performing the deregistration procedure.

The proposed method allows the UE (100) to handle the emergency call while registered for onboarding services in the SNPN. The proposed method allows the UE (100) to handle the emergency call while registered for onboarding services, a state in which no other services are allowed to the UE (100).

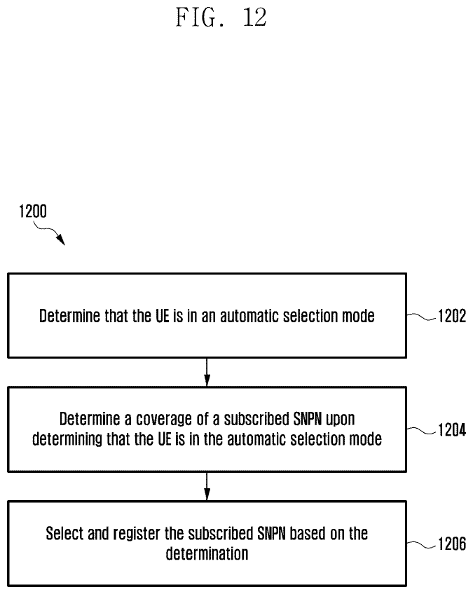

FIG. 12 illustrates a flow chart of a method for handling the operation in the SNPN, while handling the last registered SNPN, according to the embodiments as disclosed herein. The operations (1202-1206) are handled by the SNPN based controller (140).

At step 1202, the method includes determining that the UE (100) is in the automatic selection mode. At step 1204, the method includes determining the coverage of the subscribed SNPN upon determining that the UE (100) is in the automatic selection mode. At step 1206, the method includes selecting and registering the subscribed SNPN based on the determination.

Based on the proposed method, the UE selects and registers in subscribed SNPN of the entry of the “list of subscriber data” instead of the last registered SNPN. This gives the UE for a new mechanism to select a higher priority SNPN above the registered SNPN after power-up, out of service recovery and when the UE starts operating in the SNPN access operation mode.

The method can also be implemented in a wireless network that can be, for example, but not limited to a fourth generation (4G) network, a fifth generation (5G) network, an open radio access network (ORAN) or the like.

The various actions, acts, blocks, steps, or the like in the flow charts (1100 and 1200) may be performed in the order presented, in a different order or simultaneously. Further, in some embodiments, some of the actions, acts, blocks, steps, or the like may be omitted, added, modified, skipped, or the like without departing from the scope of the disclosure.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

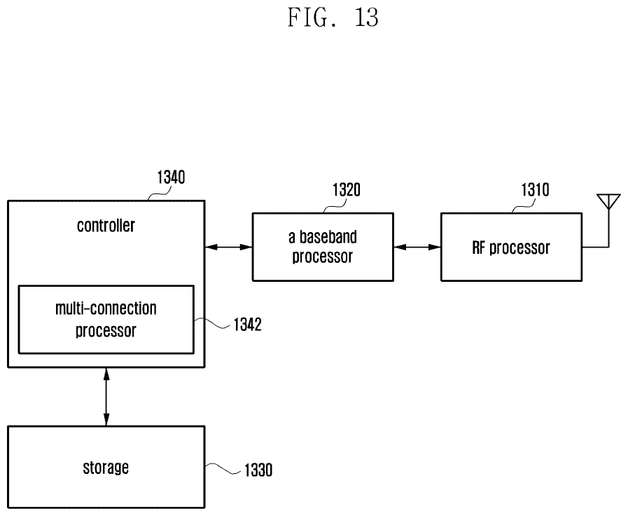

The structure of the UE to which embodiments of the disclosure can be applied is illustrated in FIG. 13.

Referring to FIG. 13, the UE includes a radio frequency (RF) processor 1310, a baseband processor 1320, a storage unit 1330, and a controller 1340.

The RF processor 1310 performs a function for transmitting and receiving a signal through a wireless channel, such as band conversion and amplification of a signal. That is, the RF processor 1310 up-converts a baseband signal provided from the baseband processor 1320 into an RF band signal, transmits the RF band signal through an antenna, and then down-converts the RF band signal received through the antenna into a baseband signal. For example, the RF processor 1310 may include a transmission filter, a reception filter, an amplifier, a mixer, an oscillator, a digital-to-analog converter (DAC), an analog-to-digital converter (ADC), and the like. Although FIG. 13 illustrates only one antenna, the UE may include a plurality of antennas. In addition, the RF processor 1310 may include a plurality of RF chains. Moreover, the RF processor 1310 may perform beamforming. For the beamforming, the RF processor 1310 may control a phase and a size of each signal transmitted/received through a plurality of antennas or antenna elements. The RF processor may perform MIMO and receive a plurality of layers when performing the MIMO operation. The RF processor 1310 may appropriately configure a plurality of antennas or antenna elements according to the control of the controller to perform reception beam sweeping or control a direction of a reception beam and a beam width so that the reception beam corresponds to a transmission beam.

The baseband processor 1320 performs a function for a conversion between a baseband signal and a bitstream according to a physical layer standard of the system. For example, when data is transmitted, the baseband processor 1320 generates complex symbols by encoding and modulating a transmission bitstream. Further, when data is received, the baseband processor 1320 reconstructs a reception bitstream by demodulating and decoding a baseband signal provided from the RF processor 1310. For example, in an orthogonal frequency division multiplexing (OFDM) scheme, when data is transmitted, the baseband processor 1320 generates complex symbols by encoding and modulating a transmission bitstream, mapping the complex symbols to subcarriers, and then configures OFDM symbols through an inverse fast Fourier transform (IFFT) operation and a cyclic prefix (CP) insertion. Further, when data is received, the baseband processor 1320 divides the baseband signal provided from the RF processor 1310 in the unit of OFDM symbols, reconstructs the signals mapped to the subcarriers through a fast Fourier transform (FFT) operation, and then reconstructs a reception bitstream through demodulation and decoding.

The baseband processor 1320 and the RF processor 1310 transmit and receive signals as described above. Accordingly, the baseband processor 1320 and the RF processor 1310 may be referred to as a transmitter, a receiver, a transceiver, or a communication unit. Further, at least one of the baseband processor 1320 and the RF processor 1310 may include a plurality of communication modules to support a plurality of different radio access technologies. In addition, at least one of the baseband processor 1320 and the RF processor 1310 may include different communication modules to process signals of different frequency bands. For example, the different radio-access technologies may include an LTE network and an NR network. Further, the different frequency bands may include a super high frequency (SHF) (for example, 2.5 GHz and 5 GHz) band and a millimeter (mm) wave (for example, 60 GHz) band.

The storage unit 1330 stores data such as basic program, an application, and setting information for the operation of the UE. The storage unit 1330 provides the stored data according to a request from the controller 1340.

The controller 1340 controls the overall operation of the UE. For example, the controller 1340 transmits/receives a signal through the baseband processor 1320 and the RF processor 1310. In addition, the controller 1340 may record data in the storage unit 1330 and read the data. To this end, the controller 1340 may include at least one processor. For example, the controller 1340 may include a communication processor (CP) that performs a control for communication, and an application processor (AP) that controls a higher layer such as an application program.

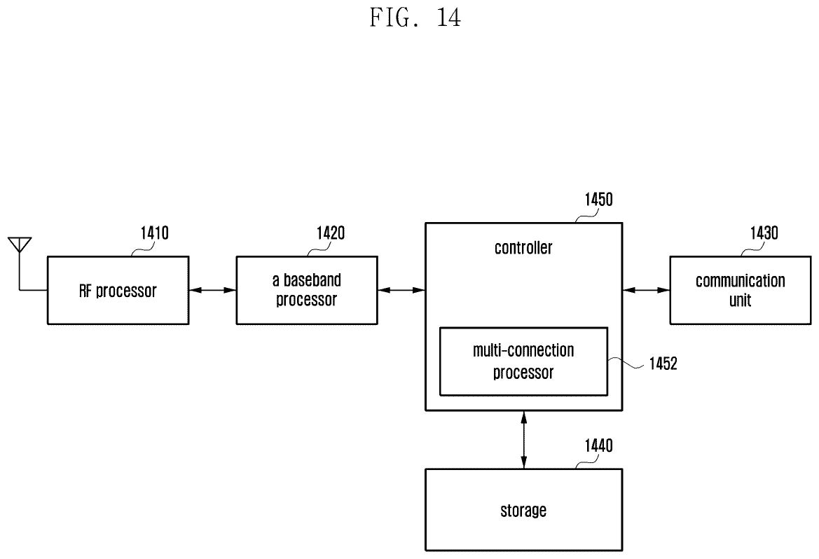

FIG. 14 illustrates a block diagram of a base station in a wireless communication system according to embodiments as disclosed herein.

As illustrated in FIG. 14, the base station includes an RF processor 1410, a baseband processor 1420, a backhaul communication unit 1430, a storage unit 1440, and a controller 1450.

The RF processor 1410 performs a function for transmitting and receiving a signal through a wireless channel, such as band conversion and amplification of a signal. That is, the RF processor 1410 up-converts a baseband signal provided from the baseband processing unit 1420 into an RF band signal and then transmits the converted signal through an antenna, and down-converts an RF band signal received through the antenna into a baseband signal. For example, the RF processor 1410 may include a transmission filter, a reception filter, an amplifier, a mixer, an oscillator, a DAC, and an ADC. Although FIG. 14 illustrates only one antenna, the first access node may include a plurality of antennas. In addition, the RF processor 1410 may include a plurality of RF chains. Moreover, the RF processor 1410 may perform beamforming. For the beamforming, the RF processor 1410 may control a phase and a size of each of the signals transmitted and received through a plurality of antennas or antenna elements. The RF processor may perform a downlink MIMO operation by transmitting one or more layers.

The baseband processor 1420 performs a function of performing conversion between a baseband signal and a bitstream according to a physical layer standard of the first radio access technology. For example, when data is transmitted, the baseband processor 1420 generates complex symbols by encoding and modulating a transmission bitstream. Further, when data is received, the baseband processor 1420 reconstructs a reception bitstream by demodulating and decoding a baseband signal provided from the RF processor 1410. For example, in an OFDM scheme, when data is transmitted, the baseband processor 1420 may generate complex symbols by encoding and modulating the transmission bitstream, map the complex symbols to subcarriers, and then configure OFDM symbols through an IFFT operation and CP insertion. In addition, when data is received, the baseband processor 1420 divides a baseband signal provided from the RF processor 1410 in units of OFDM symbols, recovers signals mapped with sub-carriers through an FFT operation, and then recovers a reception bitstream through demodulation and decoding. The baseband processor 1420 and the RF processor 1410 transmit and receive signals as described above. Accordingly, the baseband processor 1420 and the RF processor 1410 may be referred to as a transmitter, a receiver, a transceiver, or a communication unit.

The communication unit 1430 provides an interface for communicating with other nodes within the network.

The storage unit 1440 stores data such as a basic program, an application, and setting information for the operation of the MeNB. Particularly, the storage unit 1440 may store information on bearers allocated to the accessed UE and the measurement result reported from the accessed UE. Further, the storage unit 1440 may store information on a reference for determining whether to provide multiple connections to the UE or stop the multiple connections. In addition, the storage unit 1440 provides data stored therein according to a request from the controller 1450.

The controller 1450 controls the overall operation of the MeNB. For example, the controller 1450 transmits and receives a signal through the baseband processor 1420 and the RF processor 1410 or through the backhaul communication unit 1430. In addition, the controller 1450 may record data in the storage unit 1440 and read the data. To this end, the controller 1450 may include at least one processor.

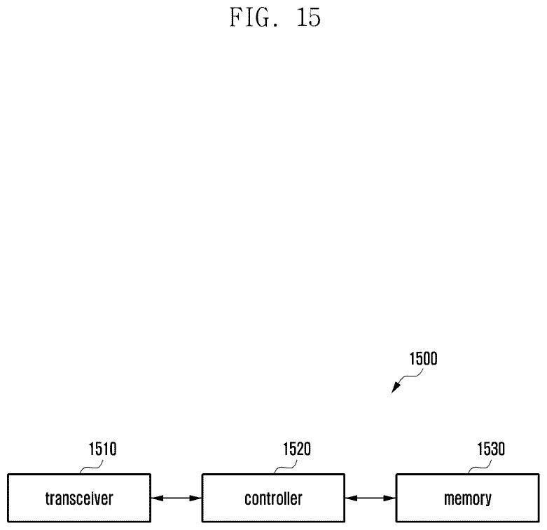

FIG. 15 illustrates a diagram of a configuration of a network entity according to embodiments as disclosed herein. Referring to FIG. 15, the network entity may include a transceiver 1510, a controller 1520, and a storage unit 1530. The controller 1520 may be defined as a circuit, an application-specific integrated circuit, or at least one processor.

The transceiver 1510 may transmit/receive signals to/from other network entities. The controller 1520 may control overall operations of the UE. The storage unit 1530 may store at least one piece of information transmitted/received through the transceiver 1510 and information produced through the controller 1520.

Various embodiments of the present disclosure may be implemented by software including an instruction stored in a machine-readable storage media readable by a machine (e.g., a computer). The machine may be a device that calls the instruction from the machine-readable storage media and operates depending on the called instruction and may include the electronic device. When the instruction is executed by the processor, the processor may perform a function corresponding to the instruction directly or using other components under the control of the processor. The instruction may include a code generated or executed by a compiler or an interpreter. The machine-readable storage media may be provided in the form of non-transitory storage media. Here, the term “non-transitory,” as used herein, is a limitation of the medium itself (i.e., tangible, not a signal) as opposed to a limitation on data storage persistency.

Although the present disclosure has been described with various embodiments, various changes and modifications may be suggested to one skilled in the art. It is intended that the present disclosure encompass such changes and modifications as fall within the scope of the appended claims.

Although the present disclosure has been described with various embodiments, various changes and modifications may be suggested to one skilled in the art. It is intended that the present disclosure encompass such changes and modifications as fall within the scope of the appended claims.

Those skilled in the art will understand that the above illustrative embodiments are described herein and are not intended to be limiting. It should be understood that any two or more of the embodiments disclosed herein may be combined in any combination. Furthermore, other embodiments may be utilized, and other changes may be made without departing from the spirit and scope of the subject matter presented herein. It will be readily understood that aspects of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a digital signal processor (DSP), an application specific integrated circuit (ASIC), a field programmable gate array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The above description is only an exemplary implementation of the present disclosure, and is not intended to limit the scope of protection of the present disclosure, which is determined by the appended claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
identifying whether the UE is registered for onboarding services in a standalone non-public network (SNPN), wherein the SNPN does not support emergency services;
in case that the UE is registered for the onboarding services in the SNPN, identifying whether a number dialed is an emergency number; and
in case that the number dialed is the emergency number, performing a procedure for an emergency.

2. The method of claim 1, further comprising:
based on the determination that the number dialed is the emergency number, performing a local de-registration.

3. The method of claim 1, performing the procedure for the emergency comprising:
performing a cell reselection to a cell that does support emergency voice calls.

4. The method of claim 1, performing the procedure for the emergency comprising:
selecting a domain for an emergency session; and
based on the selected domain, attempting to make the emergency session.

5. The method of claim 1, further comprising:
indicating, to a network entity performing an access and management function (AMF), that the UE is not registered for the onboarding services any further.

6. A method performed by a user equipment (UE) in a wireless communication system, the method comprising:
identifying whether the UE is in an automatic selection mode;
in case that the UE is in the automatic selection mode, determining a coverage of a subscribed standalone non-public network (SNPN); and
based on the determined coverage of the subscribed SNPN, registering to the subscribed SNPN.

7. The method of claim 6, further comprising:
switching on the UE; or
starting to operate in a SNPN access operation mode.

8. The method of claim 6,
wherein the UE follows a recovery from a lack of coverage.

9. The method of claim 6,
wherein the UE does not return to a registered SNPN or an equivalent SNPN after determining the coverage of the subscribed SNPN.

10. The method of claim 6,
wherein the subscribed SNPN is for a selected entry of a list of subscriber data.

11. A user equipment (UE) in a wireless communication system, the UE comprising:
a transceiver; and
a controller configured to:
identify whether the UE is registered for onboarding services in a standalone non-public network (SNPN), wherein the SNPN does not support emergency services,
in case that the UE is registered for the onboarding services in the SNPN, identify whether a number dialed is an emergency number, and
in case that the number dialed is the emergency number, perform a procedure for an emergency.

12. The UE of claim 11, wherein the controller is further configured to:
based on the determination that the number dialed is the emergency number, perform a local de-registration.

13. The UE of claim 11, wherein the controller is further configured to:
perform a cell reselection to a cell that does support emergency voice calls.

14. The UE of claim 11, wherein the controller is further configured to:
based on the selected domain, attempt to make an emergency session.

15. The UE of claim 11, wherein the controller is further configured to:
indicate, to a network entity performing an access and management function (AMF), that the UE is not registered for the onboarding services any further.

16. A user equipment (UE) in a wireless communication system, the UE comprising:
a transceiver; and
a controller configured to:
identify whether the UE is in an automatic selection mode,
in case that the UE is in the automatic selection mode, determine a coverage of a subscribed standalone non-public network (SNPN), and
based on the determined coverage of the subscribed SNPN, register to the subscribed SNPN.

17. The UE of claim 16, wherein the controller is further configured to:
switch on the UE; or
start to operate in a SNPN access operation mode.

18. The UE of claim 16
wherein the UE follows a recovery from a lack of coverage.

19. The UE of claim 16,
wherein the UE does not return to a registered SNPN or an equivalent SNPN after determining the coverage of the subscribed SNPN.

20. The UE of claim 16,
wherein the subscribed SNPN is for a selected entry of a list of subscriber data.
